(19) United States
(12) Patent Application Publication
(10) Pub. No.: US 2026/0105742 A1
(43) Pub. Date: Apr. 16, 2026

(54) GENERIC FACE IMAGE QUALITY ASSESSMENT TRANSFORMER

(71) Applicant: Snap Inc., Santa Monica, CA (US)

(72) Inventors: Jian Wang, West New York, NJ (US); Wei-Ting Chen, New York, NY (US); Sizhuo Ma, Long Island City, WI (US); Qiang Gao, San Diego, CA (US); Gurunandan Krishnan Gorumkonda, Kirkland, WA (US)

(21) Appl. No.: 18/924,488

(22) Filed: Oct. 23, 2024

Related U.S. Application Data
(60) Provisional application No. 63/707,419, filed on Oct. 15, 2024.

(51) Int. Cl. G06V 10/98; G06V 10/26; G06V 10/778; G06V 10/82; G06V 40/16

(52) U.S. Cl. CPC G06V 10/993; G06V 10/26; G06V 10/778; G06V 10/82; G06V 40/169

(57) ABSTRACT

A transformer-based network and method for generic face image quality assessment (GFIQA), predicting perceptual scores for face images. The DSL is a self-supervised approach for learning degradation features globally. This network and method effectively captures global degradation representations from both synthetically and naturally degraded images, enhancing the learning process of degradation characteristics. The network's attention is enhanced to salient facial components by integrating facial landmark detection, enabling a holistic quality evaluation that adaptively aggregates local quality assessment across the face.

### TECHNICAL FIELD

The present subject matter relates to image quality assessment of face images captured by a camera.

### BACKGROUND

Electronic devices, such as smartphones, available today integrate cameras and processors configured to capture images and manipulate the captured images.

Assessing the quality of face images is important for advanced image processors and transformers.

### BRIEF DESCRIPTION OF THE DRAWINGS

The drawing figures depict one or more implementations, by way of example only, not by way of limitations. In the figures, like reference numerals refer to the same or similar elements.

FIG. 1 is a flow diagram of a face image quality assessment network;

FIG. 2 is a method of dual-set degradation representation learning (DSL) to train the degradation extraction network in FIG. 1;

FIG. 3 is a diagrammatic representation of a machine; and

FIG. 4 a block diagram illustrating a software architecture of the machine of FIG. 3.

### DETAILED DESCRIPTION

A transformer-based network and method for generic face image quality assessment (GFIQA) that predicts perceptual scores for face images. The DSL is a self-supervised approach for learning degradation features globally. This network and method effectively captures global degradation representations from both synthetically and naturally degraded images, enhancing the learning process of degradation characteristics. The network's attention is enhanced to salient facial components by integrating facial landmark detection, enabling a holistic quality evaluation that adaptively aggregates local quality assessment across the face.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

Reference now is made in detail to the examples illustrated in the accompanying drawings and discussed below.

In the digital era, face images hold a central role in visual experiences, necessitating a robust metric for assessing their perceptual quality. This metric is crucial for not only evaluating and improving the performance of face restoration algorithms but also for assuring the quality of training datasets for generative models. Designing an effective metric for face image quality assessment presents significant challenges. The inherent complexity of human faces, characterized by nuanced visual features and expressions, greatly impacts perceived quality. Additionally, obtaining subjective scores such as Mean Opinion Scores (MOS) is difficult due to the limited availability of licensed face images and the inherent ambiguity in subjective evaluations. Compounding these challenges are facial occlusions caused by masks and accessories, which add another layer of complexity to the assessment process.

Decades of research on image quality assessment (IQA) on general images, or general IQA (GIQA), has demonstrated reliable performance across various generic IQA datasets. However, when such methods are applied to faces, they often overlook the distinct features and subtleties inherent to faces, making them less effective for face images.

Another thread of research focuses on biometric face quality assessment (BFIQA), where the goal is to ensure the quality of a given face image for robust biometric recognition. While recognizability is achieved by including factors unique to faces like clarity, pose, and lighting, it does not guarantee accurate assessment of perceptual degradation.

Generic face IQA (GFIQA) focuses exclusively on the perceptual quality of face images, as opposed to BFIQA. The approach leverages pre-trained generative models, such as StyleGAN2, to extract latent codes from input images, which are then used as references for quality assessment. Although the method shows promising prediction performance, its effectiveness reduces when input images deviate significantly in shooting angles or quality from the StyleGAN2 training data, limiting its applicability and accuracy to real-world scenarios.

This disclosure includes a network and method including a transformer-based method that addresses the limitations of the aforementioned methods. A degradation extraction module obtains degradation representations from input images as intermediate features to aid in the regression of quality scores, which is pre-trained via self-supervised learning. However, existing degradation representation learning schemes do not work well as they often makes an oversimplified assumption that the degradation is uniform across different patches of an image while being distinct from those of other images. This assumption does not hold for real-world data, where diverse degradations within a single image exist due to variations in lighting, motion, camera focus and so on. These inconsistencies may impair the effectiveness of degradation extraction and subsequently hinder the accuracy of quality score prediction.

This disclosure provides a network and method referred to herein as “Dual-Set Degradation Representation Learning” (DSL), which breaks the limits of traditional patch-based learning and extracts degradation representations from a global perspective in degradation learning. This approach is enabled by establishing correspondences between a controlled dataset of face images with synthetic degradations and a comprehensive in-the-wild dataset with realistic degradations, offering a comprehensive framework for degradation learning. This degradation representation is injected into a transformer decoder via cross-attention, enhancing the overall sensitivity to various kinds of challenging real-world image degradations.

The network and method utilizes the strong correlation between facial image quality and salient facial components such as mouth and eyes. Landmark detection is incorporated to localize and feed them as input to a model. This extra module allows the model to autonomously learn to focus on these facial components and understand their correlation with the perceptual quality of faces, which helps predict a regional confidence map that aggregates local quality evaluations across the face.

To summarize, a transformer-based network and method is disclosed that is designed for GFIQA, predicting perceptual scores for face images. The DSL is a self-supervised approach for learning degradation features globally. This network and method effectively captures global degradation representations from both synthetically and naturally degraded images, enhancing the learning process of degradation characteristics. The networks attention is enhanced to salient facial components by integrating facial landmark detection, enabling a holistic quality evaluation that adaptively aggregates local quality assessment across the face.

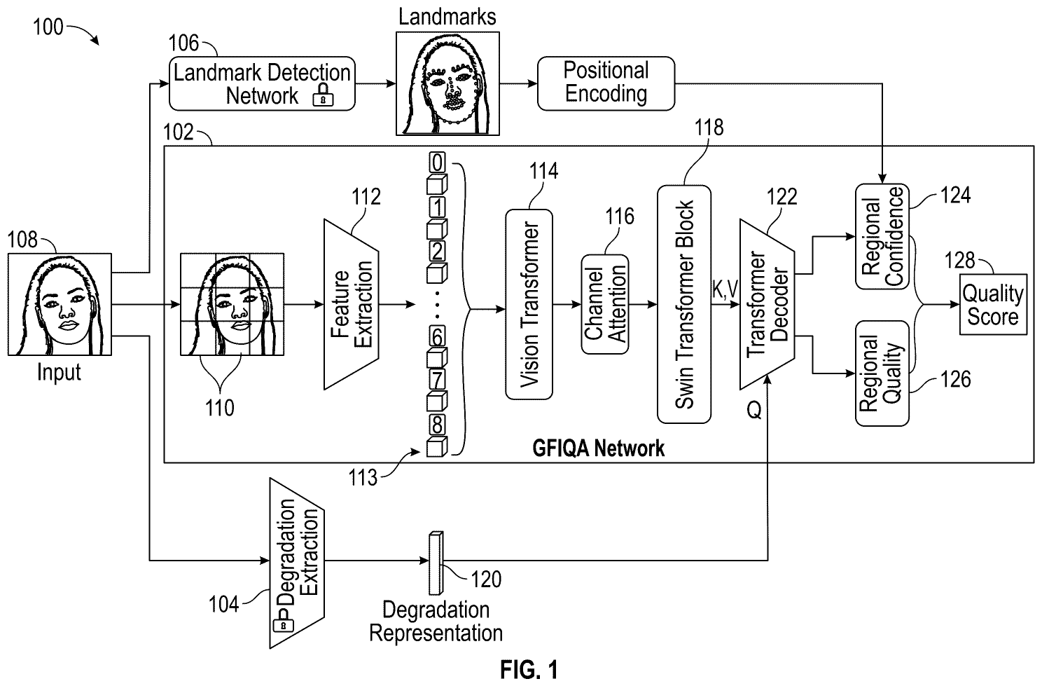

FIG. 1 illustrates a flow diagram of a image quality assessment network at 100. Network 100 includes a core GFIQA network 102, a degradation extraction network 104, and a landmark detection network 106. Face images 108 are cropped into several patches 110 to fit the input size requirements of a feature extractor 112 for a pre-trained, then fine-tuned, vision transformer (ViT) 114. Each patch 110 is then processed individually as patches 113, and their Mean Opinion Scores (MOS) are averaged to determine the final quality score. Given an input image I∈ [symbol] ^{H×W×3}, network 100 estimates its perceptual quality score.

The image 108 initially undergoes feature extraction via ViT 114, followed by a channel attention 116 that emphasizes relevant inter-channel dependencies. Subsequently, a Swin Transformer 118 refines these features, capturing subtle image details. Swin Transformer 118 was created by Ze Liu et al. associated with Microsoft. ViT 114 uses a multi-head self-attention mechanism and feedforward neural networks, while the Swin Transmformer 118 uses multi-layer shifted windows to generate a set of Swin Transformer blocks. Both transformers can be trained using backpropagation with stochastic gradient descent (SGD) or other optimization methods.

In parallel with the processing by GFIQA network 102, degradation extraction network 104 simultaneously identifies and isolates perceptual degradations within the image 108, providing a nuanced degradation representation 120 of image quality degradations.

The degradation representation 120, once extracted by degradation extraction network 104, is integrated with the outputs from the Swin Transformer 118 within a transformer decoder 122. This integration employs cross-attention to enhance network 100 sensitivity to degradation. The combined features are then directed into two multi-layer perceptron (MLP) branches. The first branch 124 predicts the regional confidence, while the second branch 126 estimates the regional quality score. Finally, these outputs are combined through a weighted sum to determine the overall quality score 128 of the image 108.

Landmark detection network 106 identifies facial key points of image 108, influencing the regional confidence evaluation and ensuring that essential facial features improve the final quality score.

During the training of the core GFIQA network 110, landmark detection network 106 and the degradation extraction network 104 remain fixed, leveraging their pre-trained knowledge. Notably, resizing input images 108 is avoided to fit the fixed input dimensions of the ViT 114, which could distort quality predictions. Instead, image 108 is cropped, each patch 113 is processed independently, and the resulting MOS predictions are averaged for a consolidated image quality score 128. This approach maintains the original dimensions of the image 108 and, consequently, the correctness of perceptual quality assessment.

Self-supervised DSL degradation representation learning.

Existing degradation extraction methods assume that patches 110 from the same image 108 share similar degradation for contrastive learning. In network 100, patches 110 extracted from the same image 108 are positive samples, while those from different images are negative samples. The patches 110 are encoded into degradation representations (x, x⁺, and x⁻) for the query, positive, and negative samples. The contrastive loss function is designed to enhance the similarity between x and x⁺ and dissimilarity between x and x⁻, which is given by:

$${ℒ}_{Patch} ( x , {x}^{+} , {x}^{-} ) = - log \frac{exp ( x \cdot {x}^{+} / θ )}{{\sum }_{n = 1}^{N} exp ( x \cdot {x}_{n}^{-} / θ )} , \qquad ( 1 )$$

where N is the number of negative samples and θ is a temperature hyper-parameter.

However, the assumption of uniform degradation across the image 108 does not always hold due to lighting, local motion, defocus, and other factors. For example, it is possible to have a moving face with a static background in image 108, which means that only some patches 110 suffer from motion blur. This oversimplified assumption often leads to suboptimal and inconsistent results for degradation learning.

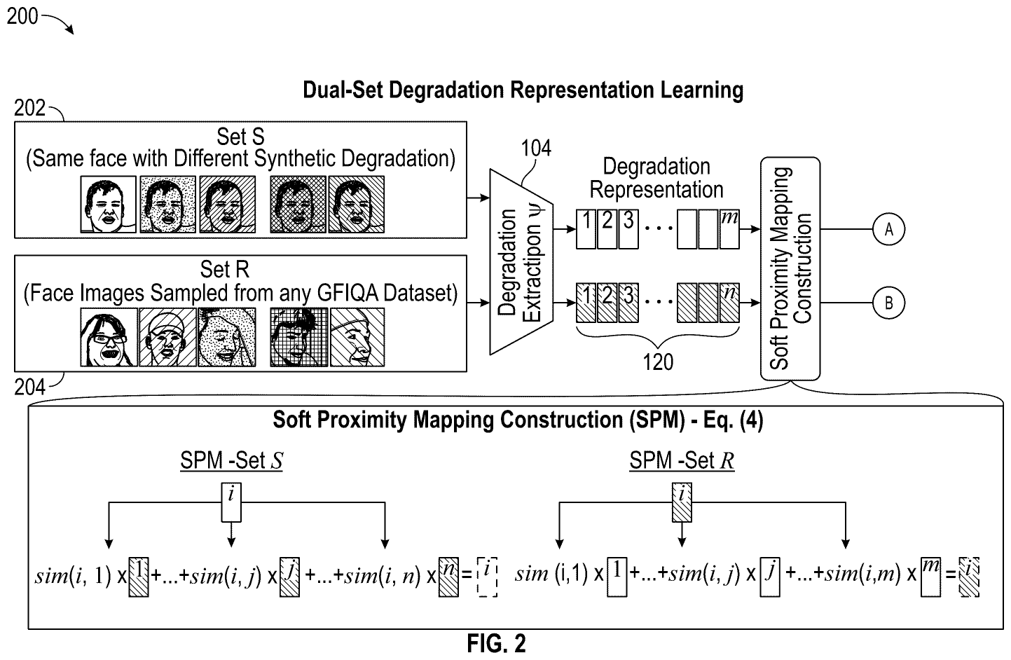

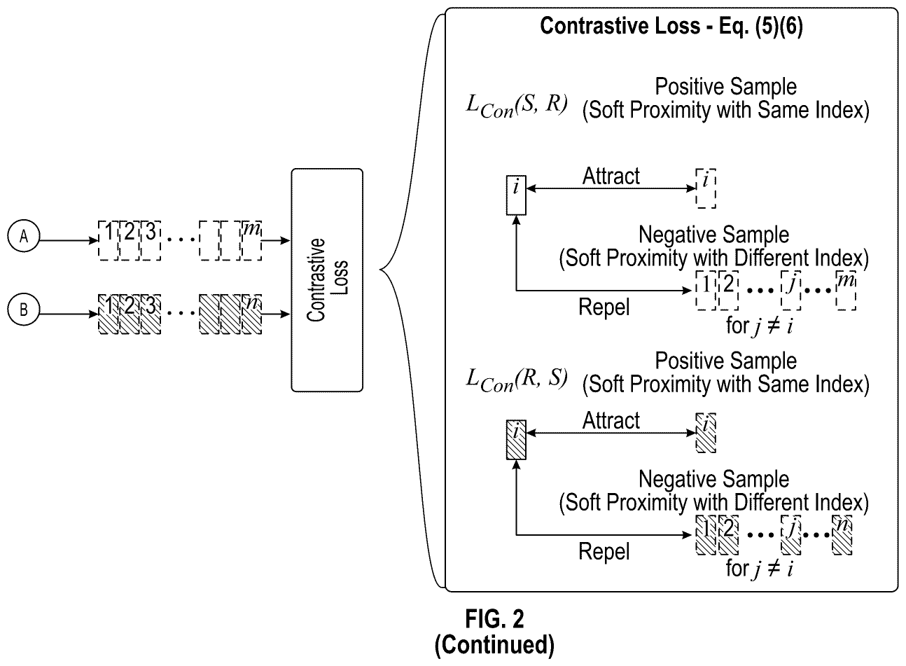

Referring to FIG. 2 there is shown a method of DSL learning at 200. To bridge this gap, DSL considers the entire face in images 108. To make this challenging setting compatible with contrastive learning approaches, two sets of images, [symbol] and [symbol] shown at 202 and 204 each serving a unique purpose in the degradation learning process.

Set [symbol] consists of a collection of images derived from a single high-quality face image, with each image undergoing different types of [symbol] ynthetic degradation including but not limited to blurring, noise, resizing, JPEG compression, and extreme lighting conditions. This Set [symbol] acts as a controlled environment, enabling in-depth exploration of a wide variety of degradations against constant content.

In contrast, Set [symbol] encompasses a compilation of real images from GFIQA datasets (for example, GFIQA-20K by Su et al, IEEE Transactions on Multimedia, 2023), each having different content under [symbol] eal-world degradation. This Set [symbol] reflects the unpredictability and diversity of realistic degradations, which are hard to model by synthetic data.

Formally, let [symbol] ={s₁, . . . , sₘ} and [symbol] ={r₁, . . . , rₙ}, where m and n represent the number of images in Set [symbol] and [symbol] , respectively. Each image from the two sets is mapped to its degradation representation by a function ψ defined by the degradation extraction module with weights z:

$${ψ}_{z}^{\to } ( 𝒮 ) = \{ ψ ( {s}_{1} ; z ) , … , ψ ( {s}_{m} ; z ) \} \qquad ( 2 )$$

$${ψ}_{z}^{\to } ( ℛ ) = \{ ψ ( {r}_{1} ; z ) , … , ψ ( {r}_{n} ; z ) \} \qquad ( 3 )$$

A mechanism termed soft proximity mapping (SPM) is used, where for a given image sᵢ from Set [symbol] , its representation ψ(sᵢ) is mapped to a linear combination of representations in ψ_{z}^{→}( [symbol] ) as follows:

$$\hat{ψ} ( {s}_{i} ) = {\sum }_{j = 1}^{n} s i m ( ψ ( {s}_{i} ) , ψ ( {r}_{j} ) ) \cdot ψ ( {r}_{j} ) \qquad ( 4 )$$

where \hat{ψ}(sᵢ) denotes soft proximity mapping of ψ(sᵢ). sim(⋅,⋅) denotes the similarity between two representations. [symbol] 2 distance is used as the similarity metric in this implementation and z is omitted for brevity.

This construction allows to define positive and negative pairs for contrastive learning. Intuitively, a degradation representation ψ(sᵢ) should be attracted to its own soft proximity mapping \hat{ψ}(sᵢ), while any other representations ψ(sⱼ) where j≠i should be repelled from this soft proximity mapping because sᵢ and sⱼ have different degradations by the dedicated construction of Set [symbol] . Then, the contrastive loss is:

$${ℒ}_{C o n} ( 𝒮 , ℛ ) = - \frac{1}{m} {\sum }_{i = 1}^{m} log \frac{exp ( sim ( ψ ( {s}_{i} ) , \hat{ψ} ( {s}_{i} ) ) / θ )}{{\sum }_{j \neq i}^{n} exp ( sim ( ψ ( {s}_{j} ) , \hat{ψ} ( {s}_{i} ) ) / θ )} \qquad ( 5 )$$

This loss function leverages the nature that within Set [symbol] , images share the same content but differ in degradations, contrasting with Set [symbol] , which varies in both aspects. By drawing the extracted degradation representation closer to its corresponding soft proximity mapping and distancing it from other soft proximity mappings, the degradation extraction module is trained to learn a global degradation representation that is independent of the image content.

Furthermore, the self-supervised dual-set contrastive learning strategy is essential for understanding various degradations, particularly in real-world scenarios. This approach is useful as it involves accurately extracting degradation representations from real-world images to approximate those in the synthetic Set [symbol] . It might seem feasible to employ contrastive learning solely on the synthetic Set [symbol] to capture degradation patterns: Positive pairs consist of images with the same degradation, and negative pairs otherwise. However, this naive approach does not generalize well to real-world images. In contrast, this dual-set design brings together the benefits of both the synthetic set with controllable degradations and the real-world set with realistic degradations, achieving better generalization.

Notice that the roles of Set [symbol] and Set [symbol] are symmetric. Just as representations from Set [symbol] are utilized to seek corresponding features within [symbol] , empirically, the reverse is also viable and informative. Thus, a Degradation Extraction Loss [symbol] _{DE} is defined as a bidirectional loss:

$${ℒ}_{D E} = {ℒ}_{C o n} ( 𝒮 , ℛ ) + {ℒ}_{C o n} ( ℛ , 𝒮 ) \qquad ( 6 )$$

This bidirectional loss reinforces the mutual learning and alignment between the synthetic and real-world sets, ensuring a comprehensive understanding and representation of realistic degradations. Moreover, the high-quality image in Set [symbol] is resampled for every iteration, where this image undergoes random synthetic degradations of varying intensities. Concurrently, images in Set [symbol] are also resampled randomly in each iteration.

In summary, DSL learning method 200 gets rid of the uniformity assumption of degradation in patches 110 across the entire image 108 for degradation learning. Instead, it relies on the soft proximity mapping between two constructed sets of images to calculate the contrastive loss, which allows for more precise degradation representation. Furthermore, since the entire image 108 is considered, DSL captures a holistic view of the degradation unique to each image 108, further boosting the performance.

Face images 108 are uniquely challenging in image processing. This is because human eyes are especially sensitive to facial artifacts, raising the importance of nuanced quality assessment. Thus, it is important to design an approach that does not treat each pixel in image 108 equally, and acknowledge the perceptual significance of salient facial features. Furthermore, considering that network 100 crops the face into various patches 110 to compute the average MOS score 128, it is important to provide landmark information to give the spatial context on which part of the face each patch 110 covers, ensuring a holistic and perceptually consistent evaluation.

As shown in FIG. 1, method 200 utilizes an existing landmark detection network 106, such as a 3 dimension morphable model (3DMM) to identify key facial landmarks in image 108. Positional encoding is applied to these unique landmark identifiers. By applying a series of sinusoidal functions to the raw identifiers, positional encoding enhances the representational capacity of network 100, allowing the network 100 to capture and learn more intricate relationships and patterns associated with each landmark identifier.

The encoded information is subsequently concatenated with the features processed by the transformer decoder 122, feeding into the regional confidence branch 124. The human visual system is particularly sensitive to high-frequency details, which are often associated with facial landmarks such as the eyes, nose, and mouth. Providing this landmark-based information to the regional confidence branch 124 helps generate a more precise confidence map, emphasizing regions that humans naturally prioritize in their perception.

In network 100, relying on encoding landmark coordinates (x, y) as image positions in an image 108, as it can introduce ambiguity during learning, e.g., when faces are unaligned, or images are cropped into patches 110. In such scenarios, specific coordinates may inconsistently correspond to different facial features on different training samples, therefore muddling the learning process. To avoid this, network 100 employs a fixed encoding scheme for each facial landmark, assigning a unique identifier to every critical feature regardless of its position in image 108. This methodology proves particularly advantageous for ViT 114, which takes fixed-size patches 110 (crop) from the input image 108, potentially capturing only portions of the face.

Given the diverse range of degradations encountered in GFIQA, off-the-shelf landmark detectors often fail on images with challenging degradations. It is observed that fine-tuning existing landmark detectors on degraded images leads to more accurate landmark detection.

In summary, by adopting landmark-guided cues, method 200 maintains a consistent awareness of crucial facial features within each patch 110, which effectively encourages the model to focus on salient facial features when aggregating the regional quality scores.

A degradation encoder of degradation extraction network 104 is trained separately by optimizing eq (6). Once trained, it remains fixed when training the core GFIQA network 102.

To measure the discrepancy between the predicted MOS and the ground truth, the Charbonnier loss ( [symbol] _{char}) is employed, which is defined as:

$${ℒ}_{c h a r} ( p , \hat{p} ) = \sqrt{{( p - \hat{p} )}^{2} + {ϵ}^{2}} \qquad ( 7 )$$

where \hat{p} is the predicted MOS, p is the ground truth MOS, and ϵ is a small constant to ensure differentiability.

Unlike existing GIQAs or GFIQAs that typically rely on [symbol] 2 losses, the Charbonnier loss is utilized as it is less sensitive to outliers, which in the context of GFIQA can arise from rare face quality degradations, dataset annotation discrepancies, or occasional extreme scores predicted by the model during training. By improving the robustness against outliers, network 100 is more aligned with human perceptual judgments.

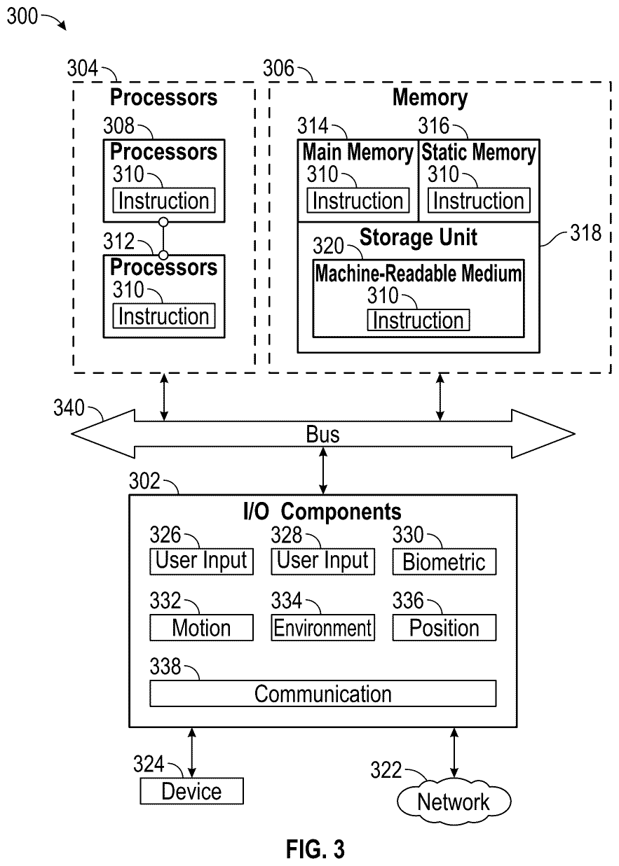

FIG. 3 is a diagrammatic representation of a machine 300 within which instructions 310 (e.g., software, a program, an application, an applet, an app, or other executable code) for causing the machine 300 to perform any one or more of the methodologies discussed herein may be executed. For example, instructions 310 may cause the machine 300 to execute any one or more of the methods described herein. Instructions 310 transform the general, non-programmed machine 300 into a particular machine 300 programmed to carry out the described and illustrated functions in the manner described. The machine 300 may operate as a standalone device or may be coupled (e.g., networked) to other machines. In a networked deployment, the machine 300 may operate in the capacity of a server machine or a client machine in a server-client network environment, or as a peer machine in a peer-to-peer (or distributed) network environment. The machine 300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 310, sequentially or otherwise, that specify actions to be taken by the machine 300. Further, while only a single machine 300 is illustrated, the term “machine” shall also be taken to include a collection of machines that individually or jointly execute instructions 310 to perform any one or more of the methodologies discussed herein. In some examples, the machine 300 may also comprise both client and server systems, with certain operations of a particular method or algorithm being performed on the server-side and with certain operations of the particular method or algorithm being performed on the client-side.

The machine 300 may include processors 304, memory 306, and input/output I/O components 302, which may be configured to communicate with each other via a bus 340. In an example, the processors 304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 308 and a processor 312 that execute the instructions 310. The term “processor” is intended to include multi-core processors that may comprise two or more independent processors (sometimes referred to as “cores”) that may execute instructions contemporaneously. Although FIG. 3 shows multiple processors 304, the machine 300 may include a single processor with a single core, a single processor with multiple cores (e.g., a multi-core processor), multiple processors with a single core, multiple processors with multiples cores, or any combination thereof.

Memory 306 includes a main memory 314, a static memory 316, and a storage unit 318, both accessible to the processors 304 via the bus 340. The main memory 306, the static memory 316, and storage unit 318 store the instructions 310 for any one or more of the methodologies or functions described herein. The instructions 310 may also reside, completely or partially, within the main memory 314, within the static memory 316, within machine-readable medium 320 within the storage unit 318, within at least one of the processors 304 (e.g., within the Processor's cache memory), or any suitable combination thereof, during execution thereof by the machine 300.

The I/O components 302 may include a wide variety of components to receive input, provide output, produce output, transmit information, exchange information, capture measurements, and so on. The specific I/O components 302 that are included in a particular machine will depend on the type of machine. For example, portable machines such as mobile phones may include a touch input device or other such input mechanisms, while a headless server machine will likely not include such a touch input device. It will be appreciated that the I/O components 302 may include many other components that are not shown in FIG. 3. In various examples, the I/O components 302 may include user output components 326 and user input components 328. The user output components 326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 302 may include biometric components 330, motion components 332, environmental components 334, or position components 336, among a wide array of other components. For example, the biometric components 330 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 332 include acceleration sensor components (e.g., accelerometer), gravitation sensor components, rotation sensor components (e.g., gyroscope).

The environmental components 334 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 336 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 302 further include communication components 338 operable to couple the machine 300 to a network 322 or devices 324 via respective coupling or connections. For example, the communication components 338 may include a network interface Component or another suitable device to interface with the network 322. In further examples, the communication components 338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 324 may be another machine or any of a wide variety of peripheral devices (e.g., a peripheral device coupled via a USB).

Moreover, the communication components 338 may detect identifiers or include components operable to detect identifiers. For example, the communication components 338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 338, such as location via Internet Protocol (IP) geolocation, location via Wi-Fi® signal triangulation, location via detecting an NFC beacon signal that may indicate a particular location, and so forth.

The various memories (e.g., main memory 314, static memory 316, and memory of the processors 304) and storage unit 318 may store one or more sets of instructions and data structures (e.g., software) embodying or used by any one or more of the methodologies or functions described herein. These instructions (e.g., the instructions 310), when executed by processors 304, cause various operations to implement the disclosed examples.

The instructions 310 may be transmitted or received over the network 322, using a transmission medium, via a network interface device (e.g., a network interface component included in the communication components 338) and using any one of several well-known transfer protocols (e.g., hypertext transfer protocol (HTTP)). Similarly, instructions 310 may be transmitted or received using a transmission medium via a coupling (e.g., a peer-to-peer coupling) to the devices 324.

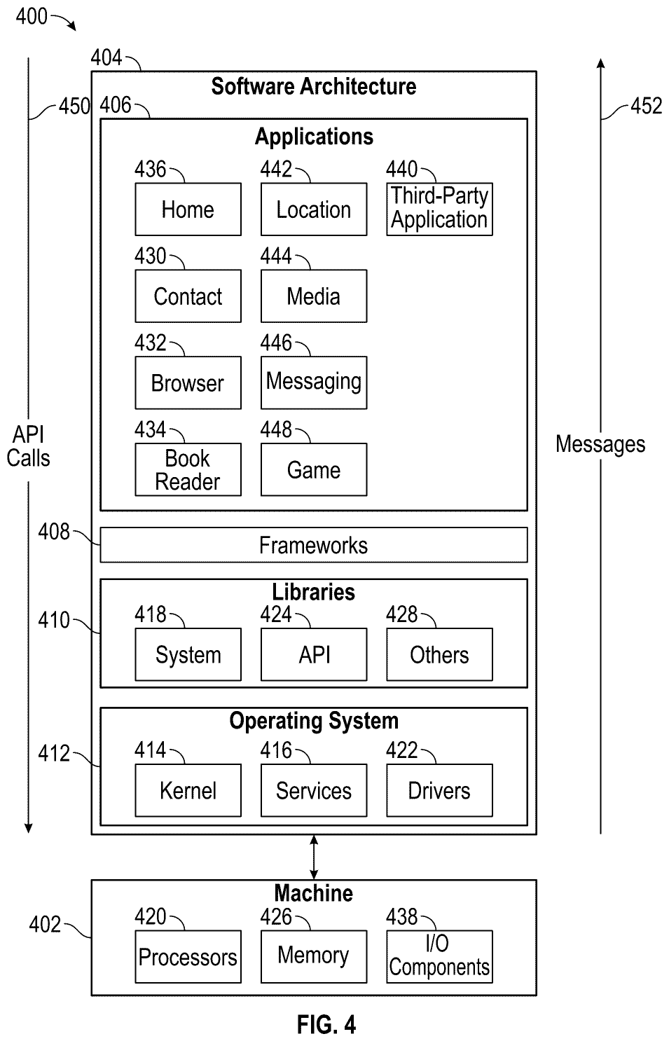

FIG. 4 is a block diagram 400 illustrating a software architecture 404, which can be installed on any one or more of the devices described herein. The software architecture 404 is supported by hardware such as a machine 402 that includes processors 420, memory 426, and I/O components 438. In this example, the software architecture 404 can be conceptualized as a stack of layers, where each layer provides a particular functionality. The software architecture 404 includes layers such as an operating system 412, libraries 410, frameworks 408, and applications 406. Operationally, the applications 406 invoke API calls 450 through the software stack and receive messages 452 in response to the API calls 450.

The operating system 412 manages hardware resources and provides common services. The operating system 412 includes, for example, a kernel 414, services 416, and drivers 422. The kernel 414 acts as an abstraction layer between the hardware and the other software layers. For example, the kernel 414 provides memory management, processor management (e.g., scheduling), component management, networking, and security settings, among other functionalities. Services 416 can provide other common services for the other software layers. The drivers 422 are responsible for controlling or interfacing with the underlying hardware. For instance, the drivers 422 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

Libraries 410 provide a common low-level infrastructure used by the applications 406. Libraries 410 can include system libraries 418 (e.g., C standard library) that provide functions such as memory allocation functions, string manipulation functions, mathematic functions, and the like. In addition, the libraries 410 can include API libraries 424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. Libraries 410 can also include a wide variety of other libraries 428 to provide many other APIs to the applications 406.

The frameworks 408 provide a common high-level infrastructure that is used by the applications 406. For example, the frameworks 408 provide various graphical user interface (GUI) functions, high-level resource management, and high-level location services. The frameworks 408 can provide a broad spectrum of other APIs that can be used by the applications 406, some of which may be specific to a particular operating system or platform.

In an example, the applications 406 may include a home application 436, a contacts application 430, a browser application 432, a book reader application 434, a location application 442, a media application 444, a messaging application 446, a game application 448, and a broad assortment of other applications such as a third-party application 440. Applications 406 are programs that execute functions defined in the programs. Various programming languages can be employed to generate one or more of the applications 406, structured in a variety of manners, such as object-oriented programming languages (e.g., Objective-C, Java, or C++) or procedural programming languages (e.g., C or assembly language). In a specific example, the third-party application 440 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 440 can invoke the API calls 450 provided by the operating system 412 to facilitate functionality described herein.

Techniques described herein may be used with one or more of the computer systems described herein or with one or more other systems. For example, the various procedures described herein may be implemented with hardware or software, or a combination of both. For example, at least one of the processor, memory, storage, output device(s), input device(s), or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an ASIC. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionalities, as described herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. An image quality assessment network, comprising:
a generic face image quality assessment (GFIQA) network having an input configured to receive an image and crop the image into a plurality of patches;
a fine-tuned vision transformer (ViT) configured to receive and process the plurality of patches;
a degradation extraction network configured to identify and isolate perceptual degradations of the image and provide a degradation representation of image quality degradations of the image;
a landmark detection network configured to identify facial key points of the image; and
a transformer decoder configured to process the fine-tuned ViT processed patches, the degradation representation, and the facial key points, and generate a score indicative of a quality of the image.

2. The image quality assessment network of claim 1, wherein each of the patches are configured to be processed independently.

3. The image quality assessment network of claim 1, wherein the degradation extraction network includes an encoder configured to encode the patches into degradation representations for a query.

4. The image quality assessment network of claim 1, wherein the landmark detection network is configured to influence regional confidence evaluation of essential facial features of the image to improve the score.

5. The image quality assessment network of claim 1, wherein the score is an average of scores of independently processed patches.

6. The image quality assessment network of claim 5, wherein each processed patch comprises a mean opinion score (MOS).

7. The image quality assessment network of claim 1, wherein the GFIQA network includes an extractor configured to crop the input images to fit fixed input dimensions of the fine-tuned ViT.

8. The image quality assessment network of claim 1, wherein the degradation extraction network is configured to operate in parallel and simultaneously identify and isolate the perceptual degradations of the image while the GFIQA network processes the image.

9. The image quality assessment network of claim 1, further comprising a channel attention block coupled to the fine-tuned ViT and configured to emphasize relevant inter-channel dependencies.

10. The image quality assessment network of claim 9, further comprising a Swin Transformer coupled to the attention block and configured to refine features and capture subtle image details.

11. The image quality assessment network of claim 1, wherein the transformer decoder comprises two multi-layer perceptron (MLP) branches, including a first branch configured to predict a regional confidence, and a second branch configured to estimate a regional quality score.

12. A method of using a generic face image quality assessment (GFIQA) network having an input configured to receive an image and crop the input image into a plurality of patches, a fine-tuned vision transformer (ViT) configured to receive and process the plurality of patches, a degradation extraction network configured to identify and isolate perceptual degradations of the image and provide a degradation representation of image quality degradations of the image, a landmark detection network configured to identify facial key points of the image, and a transformer decoder configured to process the processed patches, the degradation representation, and the facial key points from the landmark detection network, the method comprising the steps of:
the GFIQA network receiving an image and cropping the image into a plurality of patches;
the fine-tuned ViT receiving and processing the plurality of patches;
the degradation extraction network identifying and isolating perceptual degradations of the image and providing a degradation representation of image quality degradations of the image;
the landmark detection network identifying the facial key points of the image; and
the transformer decoder processing the processed patches, the degradation representation, and the facial key points from the landmark detection network, and generates a score indicative of a quality of the image.

13. The method of claim 12, wherein each of the patches are processed independently.

14. The method of claim 12, wherein the degradation extraction network includes an encoder encoding the patches into image quality assessment features for key and value samples.

15. The method of claim 12, wherein the degradation extraction network encodes the input image into degradation representations for a query.

16. The method of claim 12, wherein the landmark detection network influences regional confidence evaluation of essential facial features of the image to improve the score.

17. The method of claim 12, wherein the score is an average of scores of independently processed patches.

18. The method of claim 12, wherein the GFIQA network includes an extractor cropping the input images to fit fixed input dimensions of the fine-tuned ViT.

19. The method of claim 12, wherein the degradation extraction network operates in parallel and simultaneously identifies and isolates the perceptual degradations of the image while the GFIQA network processes the image.

20. A non-transitory computer readable storage medium that stores instructions that when executed by a processor cause the processor to process an image using a method by performing the steps of:
a generic face image quality assessment (GFIQA) network receiving an image and cropping the image into a plurality of patches;
a fine-tuned vision transformer (ViT) receiving and processing the plurality of patches;
a degradation extraction network identifying and isolating perceptual degradations of the image and providing a degradation representation of image quality degradations of the image;
a landmark detection network identifying facial key points of the image; and
a transformer decoder processing the fine-tuned ViT processed patches, the degradation representation, and the facial key points, and generating a score indicative of a quality of the image.
